(19) United States
(12) Patent Application Publication
(10) Pub. No.: US 2015/0345453 A1
(43) Pub. Date: Dec. 3, 2015

(54) DEVICE FOR SPRAYING LIQUID INTO AN OPERATING SPACE

(71) Applicant: KW-TECHNOLOGIE GMBH & CO. KG, Biberach/Riß (DE)

(72) Inventors: Stefan Schneider, Mochenwangen (DE); Sebastian Franz, Freiberg am Neckar Germany (DE); Arthur Handtmann, Biberach/Riss (DE)

(21) Appl. No.: 14/760,199

(22) PCT Filed: Jan. 10, 2014
(86) PCT No.: PCT/EP2014/000047

§ 371 Date: Jul. 9, 2015

(30) Foreign Application Priority Data
Jan. 11, 2013 (DE) 10 2013 100 239.0

(51) Int. Cl. F02M 61/18; B05B 1/04

(52) U.S. Cl. CPC F02M 61/1806; B05B 1/04

(57) ABSTRACT

The invention proposes a device for nebulizing or spraying or injecting liquid into an operating chamber, wherein at least one multi-jet nozzle (1) having at least two jet ducts (2, 3) for generating at least two liquid jets which at least partially impinge on one another in an impingement zone (7), such that a fan-shaped jet can substantially be generated, the extent of which in a fan plane is greater than, or at least twice as great as, the extent in a transverse direction with respect to said fan plane, by means of which device a highly stable and controlled fan-shaped jet is generated. This is achieved according to the invention in that a ratio (V) of a length (L) of the one or more jet ducts (2, 3) in relation to a duct diameter (D) of the one or more jet ducts (2, 3) is greater than 5 (V=L/D).

The invention relates to a device for nebulizing or spraying or injecting liquid into an operating chamber as per the preamble of claim 1.

### PRIOR ART

For example, injection devices in internal combustion engines have already long been known. For example, document DE 939 670 describes an injection device in which, in an injection nozzle, two or more jets are generated which intersect or impinge on one another in the combustion chamber. The purpose of said arrangement is that the fuel jets emerging at high speed impinge on one another in the combustion chamber, resulting in very thorough nebulization of the fuel and thus relatively small fuel droplets.

DE 10 146 642 A1 has disclosed a method for injecting fuel into a combustion chamber, wherein a rotating mist is generated by way of two or more liquid jets. Rotating mists are however uncontrollable and propagate over a large volume in the combustion chamber, with the result that fuel is deposited on the walls. Such deposition, which cannot be prevented owing to the uncontrolled swirling, however leads to disadvantageous or inadequate combustion. Owing to ever more stringent legal regulations with regard to exhaust-gas quality, a rotating, uncontrollable liquid mist is now no longer acceptable in practice in internal combustion engines.

By contrast, the applicant's generic document EP 2 390 491 A1, or DE 4 407 360 A1, discloses a corresponding device or injection nozzle, wherein a fan-shaped jet is generated, the extent of which in a fan plane is considerably greater than that in a transverse direction with respect to said fan plane. That is to say, a very flat but widely spread fan-shaped jet is generated. By means of the generation of a flat fan-shaped jet, spatial adaptation to the combustion chamber is possible. In this way, it is sought to realize as far as possible a defined and controlled combustion in the combustion chamber of an internal combustion engine, which is of crucial importance for the combustion and thus for the exhaust-gas composition.

Furthermore, the applicant's EP 2 505 820 has already disclosed an injector with multiple multi-jet nozzles, wherein, between the jet ducts or liquid jets, there is provided an offset by means of which the orientation of the fan plane is set. In this way, it is possible inter alia to realize a spatial adaptation to rather more complexly shaped combustion chambers with bulges or recesses etc.

It has however been found that, owing to extremely small fluctuations or tolerances in boundary conditions, during operation previous multi-jet nozzles generate fan-shaped jets which are not entirely spatially stable. This relates firstly to the orientation of the fan plane, that is to say the fans, in part, rotate in uncontrolled or chaotic fashion about their central axis, and secondly to the length, width and/or depth of the fan-shaped jet, that is to say the spatial extent varies in uncontrolled fashion. In this way, it is for example by all means even possible for the liquid droplets or fan-shaped jets to (briefly) make contact with a wall of the combustion chamber, which is however disadvantageous for the combustion.

### OBJECT AND ADVANTAGES OF THE INVENTION

By contrast, it is an object of the invention to propose a device for nebulizing or spraying or injecting liquid into an operating chamber, in particular for injecting fuel into a combustion chamber, by means of which device a highly stable and controlled fan-shaped jet is generated.

Proceeding from a device of the type mentioned in the introduction, said object is achieved by means of the features of claim 1. The measures specified in the subclaims permit advantageous embodiments and refinements of the invention.

Accordingly, a device according to the invention is characterized in that a ratio of a length (L) of the one or more jet ducts in relation to a duct diameter (D) of the one or more jet ducts of greater than 5 (V=L/D) is advantageous.

It has surprisingly been found that, with such an L/D ratio, a particularly high jet stability of the fan-shaped jet can be generated.

Accordingly, for this purpose, numerous parameters were tested and varied in countless tests under different test conditions. Here, it was found that specifically the L/D ratio has a crucial influence in generating a stable and reproducible collision in the impingement zone and a stable and reproducible fan-shaped jet form.

A stable and reproducible fan-shaped jet is of crucial importance for numerous applications, in particular in the case of injection of fuel into a combustion chamber of an internal combustion engine or the like. Accordingly, it was found that, for example, the temperature of the fuel or an approximately exactly set pressure of the liquid or the fuel or the counterpressure in the operating chamber etc. are, surprisingly, of secondary significance for the stability and reproducibility of the fan-shaped jet in practice.

Accordingly, it has been found from countless tests that neither the length of the one or more jet ducts nor the diameter of the one or more of jet ducts alone is of crucial importance, but the advantageous ratio of the length to the diameter of the one or more jet ducts is.

The ratio (V=L/D) is advantageously substantially between 5 and 10, preferably substantially 7. Specifically in the case of the device being used for the injection of fuel into a combustion chamber of an internal combustion engine or the like, such ratios of length to diameter of the jet duct are of particular importance for the stability of the fan-shaped jet which is formed and with regard to the impingement of the liquid jets on one another.

For example, duct diameters substantially between approximately 80 and 250 micrometers, preferably approximately 120 μm, are advantageous, in particular for motorcycles, passenger motor vehicles, heavy goods vehicles or the like. Furthermore, duct diameters of up to approximately 2 mm are conceivable for example in the case of marine diesel engines or the like.

In the case of diesel engines, it has hitherto been the case in practice that diesel fuel is injected into the combustion chamber by means of a single nozzle at a pressure of approximately 2000 bar. According to the invention, it is by contrast the case that a pressure of the liquid of the liquid jets is less than approximately 500 bar. In this way, a considerably lower pressure is required for diesel injection than in the prior art discussed above. This firstly has an advantageous effect with regard to the structural dimensioning of the required components, in particular also with regard to the outlay for sealing measures or seal elements. Secondly, it is possible in this way to realize a considerable energy saving, specifically owing to the reduced pressurization.

Advantageously, at least one of the jet ducts or all of the jet ducts have a positive conicity factor (K), wherein the conicity factor is K=(Dᵢₙₙₑᵣ−Dₒᵤₜₑᵣ)*100/L, wherein Dᵢₙₙₑᵣ is an inlet or inner diameter and Dₒᵤₜₑᵣ is an outlet or outer diameter of the one or more jet ducts as viewed in the flow direction of the liquid, and wherein L is the length of the one or more jet ducts. Alternatively or in combination herewith, an inlet cross-sectional area of the one or more jet ducts is greater than an outlet cross-sectional area of the one or more jet ducts, wherein the inlet cross section of the one or more jet ducts is arranged upstream of the outlet cross section as viewed in the flow direction of the liquid. The outlet cross section is advantageously a (clear) section/part of an (outer) envelope surface or shell surface of the nozzle body.

By means of these measures, a jet duct is advantageously dimensioned so as to be designed to narrow, or conically converge, in the flow direction. It has surprisingly been shown that a very good jet stability is produced hereby. Thus, jets are generated which, downstream of/proceeding from the outlet from the nozzle body to the impingement zone or a collision point of the jets, remain substantially stable, i.e. in particular without breaking up and without individual/some individual droplets or the like becoming separated/detached.

The substantially stable liquid jets generated by way of the above-stated measures advantageously collide with defined collision conditions in the impingement zone or at the collision point, such that a defined and highly stable fan-shaped jet is generated.

This constitutes a departure from the previous prior art, in which, rather than the provision of jet ducts which narrow in the flow direction of the liquid or of the fuel as in the present case, use was made of widening or conically diverging jet ducts. Surprisingly, by way of the departure from the previous widening of the jet ducts, it was possible for the first time to realize a stabilization and thus a considerable improvement with regard to the stability of the fan-shaped jet during the operation of advantageous multi-jet nozzles.

The conicity factor is preferably substantially between 1.0 and 3.0. By means of such an advantageous configuration of the conicity factor, it was possible to generate particularly stable fan-shaped jet conditions. This is of major importance specifically in the applications in which fuel is injected into a combustion chamber of an internal combustion engine. Here, it was for example possible to generate a relatively stable length, width and depth of the generated fan-shaped jet during operation. With this, it is possible to realize correspondingly clear and above all reproducible combustion conditions. This has a particularly advantageous effect on the attainable (average) exhaust-gas values and/or the fuel consumption.

It is advantageously the case that a distance between the nozzle body and the impingement zone and/or a collision point of the liquid jets which at least partially impinge on one another is substantially between 0 mm and 15 times a diameter (D) of the one or more jet ducts, wherein the nozzle body of the multi-jet nozzle comprises at least the two jet ducts. This can be expressed in particular as 0≦A≦15×D. In the case of internal combustion engine applications, in particular for motorcycles, passenger motor vehicles, heavy goods vehicles or the like, the distance (A) is preferably approximately between 0 and 0.9 millimeters.

It has surprisingly been found that the stability of the fan-shaped jet is dependent only to a very small extent, if at all, on an injection pressure and/or a counterpressure in the operating chamber or the combustion chamber. Rather, it has been found that the abovementioned distance is highly advantageous for the stability of the jet. For this, it was necessary to carry out countless tests with different parameter variations in order to be able to determine this advantageous distance of the collision point or of the impingement zone.

The distance is preferably substantially between 3 times and 5 times the diameter (D) of the one or more jet ducts. In the case of internal combustion engine applications in particular for motorcycles, passenger motor vehicles, heavy goods vehicles or the like, the distance (A) is advantageously between 0.5 and 0.7 mm. In this range, a particularly advantageous collision of the liquid jets is generated, wherein the liquid jets are substantially still in the form of uniform jets, and it is not the case, as in the prior art, that some individual droplets of greater or lesser size have detached therefrom. The impingement of the two liquid jets on one another takes place in correspondingly controlled fashion, such that a high level of stability of the generated fan-shaped jet is realized.

An angle between the two liquid jets is advantageously substantially between 20° and 80°. Within this angle range, it has been found that, firstly, particularly advantageous nebulization and fan-shaped jet formation is generated owing to the impingement of the two liquid jets on one another, and secondly, no disadvantageous backscatter is generated. Corresponding backscatter of the liquid jets impinging on one another would lead to a disadvantageous evaporation in the operating chamber and/or to contact between the liquid and a wall of the operating chamber, that is to say in this case in particular of the nozzle body. This would be a considerable disadvantage specifically in the case of fuel-related applications in internal combustion engines.

Advantageously, an offset is provided between central axes of the liquid jets in the impingement zone. It has been found that, by means of an offset of the central axes of the liquid jets, the orientation of the fan plane can be adjusted or rotated as required. In this way, it is possible to realize an advantageous adaptation of the generated spray to the operating chamber or the shape thereof. For example, it is possible in the case of internal combustion engine applications to realize a recess in the region of inlet and/or outlet valves or the like.

The jet ducts may be produced using a wide variety of machining methods. Firstly, cutting machining may be implemented by way of drilling. For example, by means of the chip-removing drilling method, a cylindrical form of the jet duct is realized, though a conical embodiment of the jet duct is also possible.

Secondly, it is also possible for use to be made of an erosive drilling method, in particular so-called spark-erosion drilling. Here, it is advantageously possible for all electrically conductive materials to be machined, regardless of their hardness and strength. It is also possible in this way to realize conically shaped jet ducts, in particular with undercuts, that is to say in particular it is even possible for outwardly (conically) narrowing jet ducts to be produced from the outside.

For example, use may correspondingly also be made of electron beam drilling, in particular for a face-side drilling process, or of water jet drilling or ion beam drilling, if appropriate with a coating process.

A laser drilling method is preferably used. Here, by means of a least one advantageous laser, energy is introduced in an advantageous manner locally into the workpiece such that the material is removed, in particular ionized, and vaporized. The laser drilling method permits a high level of automation and particularly precise machining dimensions and relatively complex geometries. Accordingly, it is even possible to realize conical bores, undercuts or even highly complex cross-sectional shapes and/or longitudinal sections.

Furthermore, a device according to the invention may be produced by way of a micro laser sintering method. Here, the workpiece forms are generated by way of sintering methods, with the corresponding ducts/bores being generated or formed during the production of the workpiece. Here, correspondingly complex geometries, undercuts or the like can be realized as desired. Starting materials are normally very fine-grained or powder materials which are advantageously connected to one another or sintered by way of laser beams. The nozzle body is preferably produced in layers, with the bores or recesses or the like correspondingly being left free or without deposited material.

Furthermore, it is advantageously possible for a so-called hydroerosive machining or hydroerosive grinding process to be used as a material-removing manufacturing method for the production of the device according to the invention, in particular for the reworking and/or calibration of the jet ducts in particular. Here, very small grinding particles are introduced into a liquid and pumped through the workpiece or the nozzle body at a high pressure of up to 120 bar. With this method, it is possible for the bores/jet ducts to be advantageously adjusted to the intended cross section or diameter. It is advantageously the case that, in the process, the jet ducts are rounded in particular in the region of the inlet, such that an advantageous flow of the liquid to/through the jet duct is generated during operation. For example, a rounding of 3% to 15% in relation to the maximum throughflow through the jet duct is provided during the production of the nozzle body.

In general, within the meaning of the invention, the jet ducts or the liquid jets have central axes or central longitudinal axes which, for example in the case of jet ducts of cylindrical form, exactly constitute the central axes of symmetry. In the case of correspondingly conical or frustoconical jet ducts, the central axis or central longitudinal axis likewise constitutes the central axis of symmetry.

In the case of jet ducts with possibly asymmetrical cross section, for example in the case of an elliptical cross section or the like, the central axis is, within the meaning of the invention, substantially the connecting line between the centers of area of individual parallel cross sections, in particular between the inlet area and outlet area and the centers of area thereof. Said cross sections are preferably parallel to the envelope surface or shell surface, through which the one or more jet ducts extend(s), of the nozzle body, or are in each case a (clear) partial area of the inner or outer envelope surface or shell surface through which the one or more jet ducts extend(s). In this case, the inner and the outer shell surface/envelope surface of the nozzle body encompass the respective clear cross section of the jet duct at the inlet and at the outlet for the liquid.

Within the meaning of the invention, the clear or free cross-sectional area of the jet duct at the inlet for the liquid into the nozzle body forms the inlet cross section, or advantageously encompasses the so-called inlet inner diameter. Correspondingly, within the meaning of the present invention, the clear or free cross-sectional area of the nozzle body at the outlet, that is to say at that point of the nozzle body at which the liquid exits or emerges from the nozzle body, has the outlet cross-sectional area or advantageously encompasses the outlet outer diameter of the jet duct. Correspondingly, within the meaning of the invention, in the case of a jet duct which narrows in the flow direction of the liquid, the clear outlet cross-sectional area or the outlet outer diameter is smaller than the clear inlet cross-sectional area or the inlet inner diameter of the respective jet duct.

Within the meaning of the invention, the length L of the jet duct is defined such that the two clear cross-sectional areas or the envelope surfaces/shell surfaces of the nozzle body form in each case the start and the end of the length of the jet duct. This means that the clear shell surface of the nozzle body or the corresponding respective centers of area of the inlet and outlet cross sections define the length within the meaning of the invention.

Correspondingly, within the meaning of the invention, the respective diameter D of the jet duct is defined as the diameter of the clear cross-sectional area at the inlet and at the outlet for the liquid into/out of the nozzle body/jet duct.

Within the meaning of the invention, in the case of a narrowing jet duct, the diameter D is the smallest diameter of the jet duct. This means that said diameter is preferably the outer diameter or the outlet diameter of the jet duct. Said outer diameter or outlet diameter lies in the clear cross-sectional area of the nozzle body and/or is, within the meaning of the invention, normally a part/section of the outer envelope surface or shell surface of the nozzle body.

Furthermore, within the meaning of the invention, the distance A is bounded at one side by the end of the length L of the jet duct. This means that the distance A is bounded by that envelope surface or shell surface of the nozzle body through which the one or more jet ducts extend, in particular the center of area of the clear cross section of the jet duct at the outlet out of the nozzle body for the liquid. At the other side, the distance A is defined/bounded by the impingement zone, and in this case preferably specifically by the intersection/collision point of the jets or the longitudinal axes of the jet ducts.

Within the meaning of the invention, in the case of skewed central axes or longitudinal axes of two jet ducts and/or liquid jets, the “second end” of the distance A from the nozzle body is formed by the so-called “minimum transversal” or the so-called “common perpendicular”. Here, within the meaning of the invention, the center of the common perpendicular or of the minimum transversal preferably defines the geometric endpoint of the distance A. The common perpendicular or the minimum transversal is the uniquely determinable path of least length connecting two skewed straight lines or the longitudinal axes of the jet ducts or the liquid jets. The common perpendicular or the minimum transversal is also perpendicular to both straight lines/longitudinal axes.

Accordingly, within the meaning of the invention, the length of the distance A is precisely defined at one side by the end of the length L of the jet ducts and at the other side by the crossing/intersection point of the corresponding straight lines or longitudinal axes of the liquid jets and/or of the jet ducts or, in the case of non-intersecting, that is to say skewed straight lines/longitudinal axes, by the common perpendicular or the center of said common perpendicular.

In the case of three or more jet ducts or liquid jets which impinge on or strike one another in an impingement zone, it is possible, on the one hand, for a single collision point to be generated. On the other hand, it is by all means also conceivable for two or even more collision points to be present in the impingement zone. Within the meaning of the invention, in the latter case, the distance A should then advantageously be defined/delimited by the endpoint of the length L of the jet duct and by the geometric center between corresponding collision points or between corresponding common perpendiculars or the respective centers of the latter, which in this case is simultaneously defined as the center of the impingement zone.

In general, within the meaning of the invention, the respective distance A extends along the central axis or the central longitudinal axis of the one or more jet ducts. In the case of differently angled and/or different-length distances or spacings, extending along the longitudinal axis of the respective jet duct, between nozzle body/outlet and impingement zone/crossing point/common perpendicular, the longest distance in each case is the distance A within the meaning of the invention.

### EXEMPLARY EMBODIMENT

An exemplary embodiment of the invention is illustrated in the drawing and will be discussed in more detail below on the basis of the figures, in which, in detail:

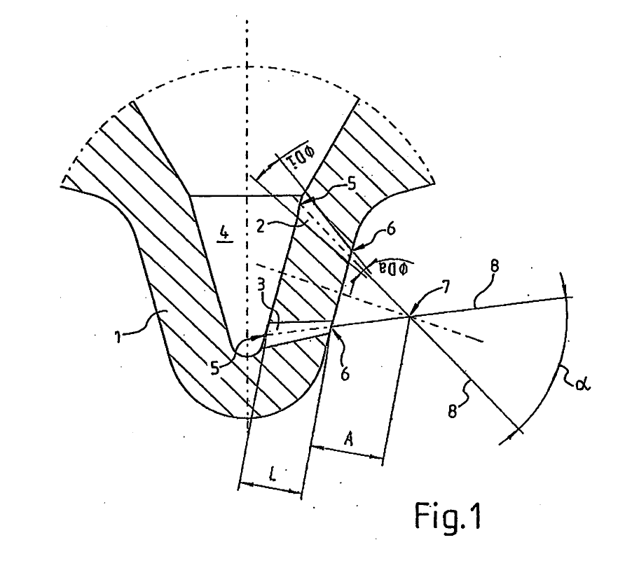

FIG. 1 shows a schematic cross section through a nozzle body with two jet ducts according to the invention, wherein the jets collide with one another at a distance A, and

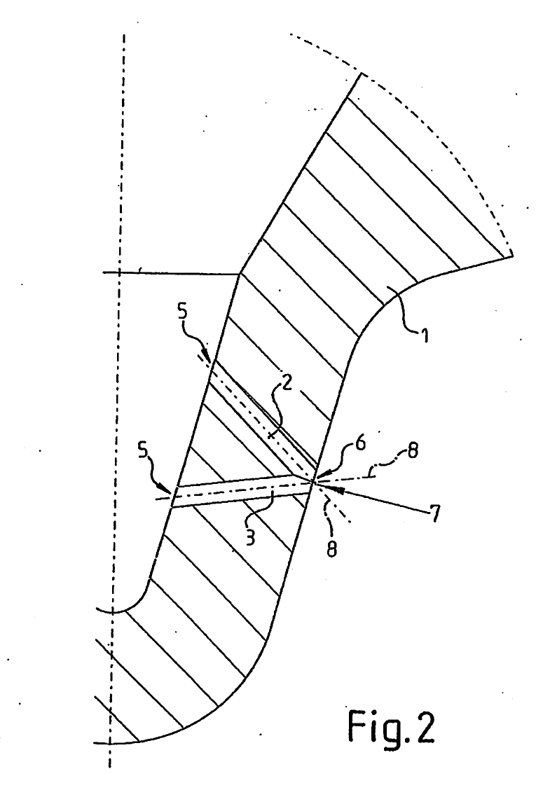

FIG. 2 shows a schematic cross section through a nozzle body according to the invention, with two jets colliding directly at the outlet of the nozzle body.

FIG. 1 illustrates a nozzle body 1 schematically in cross section, with two jet ducts 2 and 3 being provided.

During operation, a cavity 4 or an interior space 4 of the nozzle body 3 is filled with a liquid, wherein during operation or for the spraying of the liquid, the liquid is charged with a pressure p. The pressure p is preferably less than 500 bar.

The liquid, which is not illustrated in any more detail in FIG. 1, flows from the interior space 4 through the jet ducts 2, 3, entering in each case at an inlet 5 and emerging from the jet duct 2, 3 and from the nozzle body 1 at an outlet 6. The jet ducts 2, 3 each generate a liquid jet, said liquid jets being oriented at an angle α with respect to one another. In the embodiment as per FIG. 1, the two liquid jets impinge on one another at a collision point 7, and generate a fan-shaped jet within the meaning of the invention.

In the present case, in the exemplary embodiment, the jet ducts 2, 3 are assumed to each be of conical form. This means that the two jet ducts 2, 3 each have a longitudinal/central axis 8 which, in the design variant here, are positioned centrally as the axis of symmetry 8 of the respective jet duct 2, 3. In the present case, the two central axes 8 intersect at an angle α at the collision point 7.

The respective inlet 5 encompasses a clear cross section or a clear cross-sectional area which, within the meaning of the invention, is defined as part of a (curved) inner envelope surface or shell surface of the nozzle body 1. Correspondingly, an outlet 6 is formed as the clear cross section or clear cross-sectional area of a (curved) outer shell surface of the nozzle body 1 or of the envelope of the nozzle body 1. The inlet 5 and the outlet 6 encompass in each case a diameter D of the jet duct 2, 3 within the meaning of the invention. The diameter D may, at one side, be an inner diameter Dᵢₙₙₑᵣ which is present at the inlet 5 of the jet duct 2, 3, and/or may, at the other side, be an outer diameter Dₒᵤₜₑᵣ which is present at the outlet 6 of the jet duct 2, 3.

Within the meaning of the invention, the diameter D may, with regard to the respective clear cross-sectional area, be configured as a smallest diameter D of the respective clear cross-sectional areas or as a (geometrically) average diameter D of the clear cross-sectional area.

Since, in the present case, the exemplary embodiment as per FIG. 1 concerns a frustoconical jet duct 2, 3, an elliptical inlet 5 and an elliptical outlet 6 are realized owing to the oblique or angular orientation of the two jet ducts 2, 5 in relation to the nozzle body 1 or in relation to the inner and/or outer shell surface/envelope thereof. Within the meaning of the invention, the advantageous diameter D or Dᵢₙₙₑᵣ or Dₒᵤₜₑᵣ is in each case the smaller diameter D of the jet duct 2, 3. That is to say, in the case of the jet duct 2, 3 which narrows/decreases in size in the flow direction of the liquid (from the inside to the outside), this is the outer diameter Dₒᵤₜₑᵣ as per FIG. 1.

In the exemplary embodiment as per FIG. 1 or 2, it is accordingly the case that the advantageous ratio (V) of L to D (V=L/D) is to be determined using the outer diameter D=Dₒᵤₜₑᵣ, or the smallest diameter of the jet duct 2, 3.

As can be seen from FIG. 1, L is the length L of the jet duct 2, 3 between the inlet 5 and the outlet 6, that is to say in particular the centers of area thereof, or between the central points of the inner diameter Dᵢₙₙₑᵣ and of the outer diameter Dₒᵤₜₑᵣ of the respective jet duct 2, 3.

The distance A between the collision point 7 and nozzle body 1 is, in the present case, the distance or length along the angle bisector (illustrated by the dashed lines) of the two central axes 8 of the jet ducts 2, 3. The angle α is preferably between 20° and 80°, such that the angle bisector is correspondingly oriented at 10° to 40°, or α/2, with respect to the in this case symmetrically arranged jet ducts 2, 3 or the central axes 8 thereof.

Furthermore, an embodiment may be realized in which the two jet ducts 2, 3 are arranged offset with respect to one another perpendicular or at right angles to the plane of the figures/page, such that the two longitudinal/central axes 8 of the two jet ducts 2, 3 do not intersect/cross or collide with one another at one point. However, the liquid jets do collide. Thus, in this case, there is a distance between the longitudinal axes perpendicular to the plane of the page or plane of the figure, said distance being referred to, in mathematical terms, as the so-called “common perpendicular” or “minimum transversal” of the corresponding “skewed straight lines” 8. In this case, within the meaning of the invention, the distance A would be the distance from the center of the common perpendicular between the two central axes 8 to the nozzle body 1 or to the end of the illustrated length L of the jet duct 2, 3.

With such an offset or common perpendicular between the corresponding skewed straight lines 8, it is advantageously possible for the orientation of the fan which is to be generated, or of the fan plane thereof, to be adjusted or rotated.

FIG. 2 illustrates a further variant of the invention, in which the longitudinal/central axes 8 of the jet ducts 2, 3 intersect or cross approximately on the shell surface or envelope of the nozzle body 1. Consequently, in this case, the distance A is equal to zero.

### LIST OF REFERENCE SIGNS

1 Nozzle body
2 Jet duct
3 Jet duct
4 Interior space
5 Inlet
6 Outlet
7 Collision point
8 Axis
α Angle
A Distance
D Diameter
Dᵢₙₙₑᵣ Inner diameter
Dₒᵤₜₑᵣ Outer diameter
K Conicity factor
L Length

What is claimed is:

1. A device for nebulizing or spraying or injecting liquid into an operating chamber, wherein at least one multi-jet nozzle (1) having at least two jet ducts (2, 3) for generating at least two liquid jets which at least partially impinge on one another in an impingement zone (7), such that a fan-shaped jet can substantially be generated, the extent of which in a fan plane is greater than, or at least twice as great as, the extent in a transverse direction with respect to said fan plane, characterized in that a ratio (V) of a length (L) of the one or more jet ducts (2, 3) in relation to a duct diameter (D) of the one or more jet ducts (2, 3) is greater than 5 (V=LID).

2. The device as claimed in claim 1, characterized in that the ratio (V) is between 5 and 10.

3. The device as claimed in one of the preceding claims, characterized in that the ratio (V) is substantially 7.

4. The device as claimed in one of the preceding claims, characterized in that a pressure (p) of the liquid of the liquid jets is lower than 500 bar.

5. The device as claimed in one of the preceding claims, characterized in that at least one of the jet ducts (2, 3) or all of the jet ducts (2, 3) have a positive conicity factor (K), wherein the conicity factor is K=(Dᵢₙₙₑᵣ−Dₒᵤₜₑᵣ)*100/L, wherein Dᵢₙₙₑᵣ is an inlet or inner diameter (D) and Dₒᵤₜₑᵣ is an outlet or outer diameter (D) of the one or more jet ducts (2, 3), and wherein L is the length of the one or more jet ducts (2, 3), and/or in that an inlet cross-sectional area of the one or more jet ducts (2, 3) is greater than an outlet cross-sectional area of the one or more jet ducts (2, 3), wherein the inlet cross section of the one or more jet ducts (2, 3) is arranged upstream of the outlet cross section as viewed in the flow direction of the liquid.

6. The device as claimed in one of the preceding claims, characterized in that the conicity factor (K) is between 1.0 and 3.0.

7. The device as claimed in one of the preceding claims, characterized in that a distance (A) between the nozzle body (1) and the impingement zone (7) and/or a collision point (7) of the liquid jets which at least partially impinge on one another is between 0 millimeters (mm) and 15 times a diameter (D) of the one or more jet ducts (2, 3), wherein the nozzle body (1) of the multi-jet nozzle (1) comprises at least the two jet ducts (2, 3).

8. The device as claimed in one of the preceding claims, characterized in that the distance (A) is between 3 times and 7 times the diameter (D) of the one or more jet ducts (2, 3).

9. An injector having a device for injecting fuel into a combustion chamber, characterized in that said injector comprises at least one device as claimed in one of the preceding claims.

10. An internal combustion engine having a device for injecting fuel into a combustion chamber, characterized in that at least one device as claimed in one of the preceding claims is provided.
